(19) United States
(12) Patent Application Publication
(10) Pub. No.: US 2005/0220301 A1
(43) Pub. Date: Oct. 6, 2005

(54) Method and system of communication using quantum cryptography

(75) Inventor: Karl Svozil, Vienna (AT)

Correspondence Address: Ladas & Parry, 26 West 61st Street, New York, NY, 10023, US

(73) Assignees: AUSTRIA WIRTSCHAFTSSERVICE GESELLSCHAFT MIT BESCHRANKTER HAFTUNG; KARL SVOZIL

(21) Appl. No.: 10/818,995

(22) Filed: Apr. 6, 2004

(51) Int. Cl. H04K 1/00

(52) U.S. Cl. 380/41

(57) ABSTRACT

The present invention relates to a communication method and system using quantum cryptography. The system comprises a light source (1) for sending single-photon signals, means (3) for generating a signal modulating the single-photon signals with the information, which should be encrypted, means (4) for transforming the single-photon signals to a coherent superposition of at least two constituent states (S₁, S₂) according to a unitary transformation (T), at least two transmitting channels (5, 6) for transmitting each of said at least two constituent states (S₁, S₂), means (7) for recombining said constituent states (S₁, S₂) according to a transformation (T⁻¹) which is inverse to said unitary transformation (T), and means (8, 9) for reconstruction of said information of said recombined constituent states of the single-photon signal.

### BACKGROUND OF THE INVENTION

The present invention relates to the field of quantum cryptography. Quantum cryptography, using certain characteristic features of quantum mechanics, represents one of the first commercial applications of quantum information theory.

The basic idea of quantum cryptography is to send an encrypted message in the form of photonic states over a public quantum channel. Any attempt of eavesdropping would be detected, since this would result in a modification of the state of the photons.

For instance, Gisin et. al gives a survey of the state of the art in quantum cryptography (N. Gisin et al.: Quantum Cryptography; Reviews of Modern Physics, vol. 74, pp. 145-195, January 2002).

U.S. Pat. No. 6,522,749 B2 describes a quantum cryptographic communication channel based on quantum coherence. This invention uses the quantum coherence properties between two single photon sources. According to one embodiment of this invention, two identical nonlinear crystals are used.

U.S. Pat. No. 6,529,601 B1 shows a method and apparatus for polarization-insensitive quantum cryptography for the secure distribution of a key. A single-photon signal is phase modulated and transmitted over a pair of time-multiplexed transmission paths. This method uses time delays and interference of signals.

U.S. Pat. No. 5,764,765 A describes another method for key distribution using quantum cryptography, where two stations each independently modulate a single-photon signal. The single-photon signal is transmitted to the two stations from an external source, and passes through the stations in series. The protocol for generation of the encryption key is similar to the so-called BB84 protocol, proposed in 1984 by Charles H. Bennett and Gilles Brassard.

Most quantum cryptographic methods are used only for secretly distributing encryption keys that can be used to classically encrypt publicly transmitted messages between two parties.

Normally, the sender prepares a twin-particle quantum mechanical state, consisting of two and only two quantum mechanical particles; e.g. photons. Preparation of such entangled quantum states is relatively complex. Therefore, entangled photons normally are only used for generating and distributing encryption keys and not for the direct encryption of information.

### SUMMARY OF THE INVENTION

It is an object of the present invention to provide a method and system of communication using quantum cryptography which is less complex than known methods and systems.

It is a further object of the present invention to provide a method and system of communication using quantum cryptography which enables direct encryption of data and not only generation and distribution of encryption keys.

It is a further object of the present invention to provide a method and system of communication using quantum cryptography which is as secure as possible.

These objects are achieved by a method of communication using quantum cryptography, whereby the quantum states of single photons emitted by a light source and modulated by the information to be encrypted are transformed to a coherent superposition of at least two constituent states according to a unitary transformation, said at least two constituent states are transmitted in at least two separated quantum channels and said at least two constituent states are recombined according to a transformation, which is inverse to said unitary transformation, and whereby the information is reconstructed of the recombined constituent states the single photon signal. Only the coherent superposition of these pure states is in a predefined state, whereas one or all of the constituent states are not. Only the coherently combined states yield the encoded information, the constituents or shares do not. Therefore it is not possible to recover the message by only one constituent state. The present invention uses the physical effect of the coherence of quantum states. While the present state of quantum cryptography concentrates mainly on quantum entanglement, the present invention utilizes quantum coherence. One party receives one part or share of a quantum state and the other party receives the other part of a quantum state. The constituent states or shares can be regarded as components of a vector lying in subspaces of a higher-dimensional Hilbert space. While the possible quantum states of the single photons to be sent are orthogonal, the constituent states are not. As a result all constituent states must be put together to decipher the information. Since the method of communication according to the present invention is not as complex as the entanglement of photons, it is possible not only to generate and distribute encryption keys but also to encrypt the information directly. Furthermore, the method of communication using quantum cryptography according to the present invention represents a very secure cryptographic method when using a high number of constituent states and a high number of quantum channels. It is not possible to reconstruct the information by only recombining a part of the number of constituent states. Eavesdropping of only one quantum channel destroys the phase information of each share and therefore leads to an irreversible loss of information. Transformation according to the unitary transformation as well as the re-transformation according to an inverse unitary transformation can be realized in different ways using well known components like beam splitters of phase shifters.

The single-photon signals can, for instance, be produced by a laser diode. Such single-photon signals can easily be realized using standard semiconductor lasers together with suitable attenuators.

According to a further feature of the present invention, said at least two constituent states are transmitted via fiber optics. Fiber optics causes very low losses to the optical signals.

It is also possible to transmit said at least two constituent states via free space length in form of so called line-of-sight communication systems. Transmission over free space features offers some advantages compared to the use of optical fibers.

According to a further feature of the present invention, the quantum states of the single photons are transformed to a coherent superposition of at least two constituent states, and said at least two constituent states are recombined by beam splitting. Such beam splitters are commonly used in quantum cryptography, for instance in a Mach-Zehnder interferometer.

According to an alternative version, the quantum states of the single photons can be transformed to a coherent superposition of at least two constituent states, and said at least two constituent states can be recombined by phase shifting. These methods are well known methods in the field of quantum cryptography.

The objects of the present invention are achieved also by a system for communication, using quantum cryptography comprising a light source for sending single-photon signals, means for generating a signal modulating the single-photon signals with the information, which should be encrypted, means for transforming the single photon signals to a coherent superposition of at least two constituent states according to a unitary transformation, at least two transmitting channels for transmitting each of said at least two constituent states, means for recombining said constituent states according to a transformation, which is inverse to said unitary transformation, and means for reconstruction of said information of the recombined constituent states of the single-photon signal.

The means for transforming the single-photon signals and the means for recombining the constituent states according to the inverse unitary transformation can be realized by beam splitters or phase modulators.

According to a further feature of the present invention, the light source of the communication system can be a laser diode. The transmitting channels can be realized by both fiber optics or free space links as described above.

The present invention can be used for encryption of messages and not only for generating and distributing encryption keys. The present method is not so complex as the generation of entangled photons used by most of the present available systems.

### BRIEF DESCRIPTION OF THE DRAWINGS

The present invention will be described in further detail with reference to the accompanying drawings, in which:

FIG. 1 shows a block diagramm of a system of communication using quantum cryptography according to the present invention,

FIG. 2 shows one example of a realisation of a means for transforming the single-photon signals into two constituent states according to a unitary transformation; and

FIG. 3 shows one example of a realisation of the means for recombining two constituent states according to an inverse unitary transformation.

### DETAILED DESCRIPTION OF EXEMPLARY EMBODIMENTS

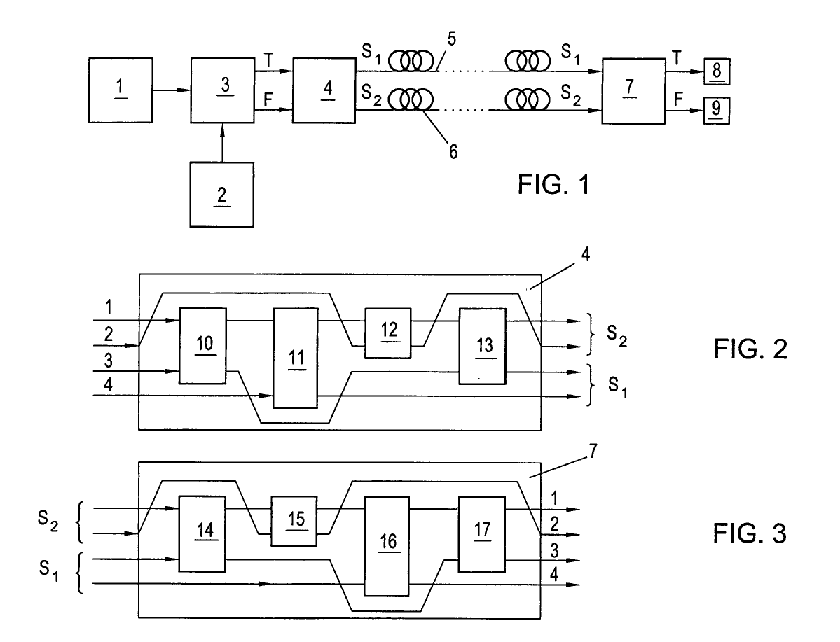

FIG. 1 shows a block diagramm of a system of communication using quantum cryptography according to the present invention. A light source 1, for instance a laser diode, generates single photons. The information of an information source 2 which should be encrypted modulates the single photons in modulator 3, resulting in a single photon in output T or F, respectively. Means 4 transform the single-photon signals of port T and F to a coherent superposition of two constituent states S₁, S₂ according to a unitary transformation. These constituent states S₁, S₂ can be transmitted via separated fiber optics 5, 7. In the receiver, the two constituent states S₁, S₂ are recombined in means 7 according to a transformation, which is inverse to said unitary transformation performed in means 4. As a result of the recombination of the constituent states, single-photon signals will be present on the two output ports T and F. Detectors 8, 9 detect the respective single-photon signals and the original information can be reconstructed.

Instead of two constituent states S₁, S₂ more constituent states S₁ to Sₙ can be generated according to a unitary transformation. These constituent states S₁ to Sₙ will be transmitted on n separated fiber optics, resulting in an increased security of the transmission of the encrypted information. Only with eavesdropping on each of these n fiber optics recovering of the information would be possible.

Instead of fiber optics 5, 7, also free-space links can be used as quantum channels for transmitting the constituent states S₁, S₂ of single photon states.

An example for the practical realisation of a unitary transformation is given by K. Svozil in “Single particle interferometric analogues of multipartite entanglement” (http://www.arxiv.org/abs/quant-ph/0401113).

FIG. 2 depicts one example of a realisation of a means 4 for transforming the single-photon signals into two shares S₁ and S₂ according to a unitary transformation and FIG. 3 depicts one example of a practical realisation of the means 7 for recombining the two shares S₁ and S₂ according to the inverse unitary transformation. FIGS. 2 and 3 will be described considering the following example.

### EXAMPLE

In the following, a mathematical description of the present invention is given. As outlined above, the constituent states or shares can be regarded as components of a vector lying in subspaces of a higher-dimensional Hilbert space.

Consider an orthonormal basis ε={e₁, . . . , eₙ} of the n-dimensional real Hilbert space Rⁿ [whose origin is at (0, . . . , 0)]. Every point x in Rⁿ has a coordinate representation xᵢ= [symbol] x|eᵢ [symbol] , i=1, . . . , n with respect to the basis E. Hence, any vector from the origin v=x has a representation in terms of the basis vectors given by

$$v = {\sum }_{i = 1}^{n} 〈 v \vert {e}_{i} 〉 {e}_{i} = v {\sum }_{i = 1}^{n} [ {e}_{i}^{T} {e}_{i} ]$$

where the matrix notation has been used, in which eᵢ and v are row vectors and “T” indicates transposition. ( [symbol] •|• [symbol] and the matrix [eᵢ^{T}eᵢ] stands for the scalar product and the dyadic product of the vector eᵢ with itself, respectively) Hence,

$${\sum }_{i = 1}^{n} [ {e}_{i}^{T} {e}_{i} ] = {I}_{n} ,$$

where Iₙ is the n-dimensional identity matrix.

Next, consider more general, redundant, bases consisting of systems of “well-arranged” linear dependent vectors [symbol] ={f₁, . . . , fₘ} with m>n, which are the orthogonal projections of orthonormal bases of m- (i.e., higher-than-n-) dimensional Hilbert spaces. Such systems are are often referred to as eutactic stars. When properly normed, the sum of the dyadic products of their vectors yields unity; i.e.,

$${\sum }_{i = 1}^{m} [ {f}_{i}^{T} {f}_{i} ] = {I}_{n} ,$$

giving raise to redundant eutactic coordinates xᵢ′= [symbol] x|fᵢ [symbol] , i=1, . . . , m>n. Indeed, many properties of operators and tensors defined with respect to standard orthonormal bases directly translate into eutactic coordinates.

In terms of m-ary (radix m) measures of quantum information based on state partitions, k elementary m-state systems can carry k nits. A nit can be encoded by the one-dimensional subspaces of R^{m} spanned by some orthonormal basis vectors ε′={e₁, . . . , eₘ}. In the quantum logic approach pioneered by Birkhoff and von Neumann, every such basis vector corresponds to the physical proposition that “the system is in a particular one of m different states.” All the propositions corresponding to orthogonal base vectors are comeasurable.

On the contrary, the propositions corresponding to the eutactic star [symbol]
={Pe₁, . . . , Peₘ}
formed by some orthogonal projection P of ε′ is no longer comeasurable (or it just spans a one-dimensional subspace). Neither is the eutactic star [symbol]
^{⊥}={P^{⊥}e₁, . . . , P^{⊥}eₘ}
formed by the orthogonal projection P^{⊥} of ε′. Indeed, the elements of [symbol] and [symbol] ^{⊥} may be considered as “shares” in the context of quantum secret sharing. Thereby, not all shares may be equally suitable for cryptographic purposes. This scenario can be generalized to multiple shares in a straightforward way.

Let us consider an example for a two-component two-share configuration, in which each party obtains one substate from two possible ones. In particular, consider the two shares or constituent states {w,x} and {y,z} defined in four dimensional complex Hilbert space by

$$w = ( 0 , 0 - \frac{1}{2 \sqrt{2}} , \frac{1}{\sqrt{2}} ) , x = \frac{1}{2} ( 0 , 0 - \frac{3}{2} , - 1 ) , \qquad ( 1 )$$

While {w,x} and {y,z} constitute eutactic stars in R², the coherent superposition of w with y, and x with z yield two orthogonal vectors in R⁴:

$$\{ w + y , x + z \} \\ \{ \frac{1}{2} ( \frac{1}{\sqrt{2}} , - 1 , - \frac{1}{\sqrt{2}} , \sqrt{2} ) , \frac{1}{2} ( - \frac{1}{2} , - \frac{1}{\sqrt{2}} , - \frac{3}{2} , - 1 ) \} , \qquad ( 2 )$$

which could be used as a bit representation. As can be readily verified, the shares in Equation (1) are obtained by applying the projections P=diag(1,1,0,0) and P^{⊥}=diag(0,0,1,1) to the vectors in Eq. (2) [“diag (a,b, . . . )” stands for the diagonal matrix with a,b, . . . at the diagonal entries]. The comeasurable projection operators corresponding to the vectors in Equation (2) are given by

$$\begin{matrix}[ {( w + y )}^{T} ( w + y ) ] = \frac{1}{4} ( \begin{matrix}\frac{1}{2} & - \frac{1}{\sqrt{2}} & - \frac{1}{2} & 1 \\ - \frac{1}{\sqrt{2}} & 1 & \frac{1}{\sqrt{2}} & - \sqrt{2} \\ - \frac{1}{2} & \frac{1}{\sqrt{2}} & \frac{1}{2} & - 1 \\ 1 & - \sqrt{2} & - 1 & 2\end{matrix} ) \\ and & ( 3 ) \\ [ {( x + z )}^{T} ( x + z ) ] = \frac{1}{4} ( \begin{matrix}\frac{1}{4} & - \frac{1}{2 \sqrt{2}} & \frac{3}{4} & \frac{1}{2} \\ \frac{1}{2 \sqrt{2}} & \frac{1}{2} & \frac{3}{2 \sqrt{2}} & \frac{1}{\sqrt{2}} \\ \frac{3}{4} & \frac{3}{2 \sqrt{2}} & \frac{9}{4} & \frac{3}{2} \\ \frac{1}{2} & \frac{1}{\sqrt{2}} & \frac{3}{2} & 1\end{matrix} ) & ( 4 )\end{matrix}$$

whereas the shares given to the parties are not comeasurable; i.e., [w^{T}w][x^{T}]−[x^{T}x][w^{T}w]≠0, and [y^{T}y][z^{T}z]−[z^{T}z][y^{T}y]≠0. Only after recombining the shares it is possible to reconstruct the information; i.e., to decide whether (w+y) or (x+z) has been communicated. This configuration demonstrates the protocol, but it is not optimal, as four dimensions have been used to represent a single bit. A more effective coding in base four could utilize the additional two “quadrit” states (1/2)(1,√2,−1,0) and (1/2)(3/2,−1/√2,1/2,−1).

A possible experimental realization of an arbitrary m-dimensional configuration could be a general interferometer with m inputs and m output terminals, which are partitioned according to the orthogonal projections involved. They should be arranged in such a way that the single input/output terminals each correspond to one dimension. Consider, for example, the two-component two-share configuration discussed above. The two bit states according to Eq. (2) can be constructed from the orthogonal pair of vectors e₁=(0, 0, 0, 1) and e₂=(1, 0, 0, 0) by subjecting them to four successive rotations in two-dimensional subspaces of R⁴, i.e., w+y=R₁₃(π/4)R₁₂(π/4)R₁₄(π/4)R₁₃(π/4)e₁ and x+z=R₁₃ (π/4)R₁₂(π/4)R₁₄(π/4)R₁₃(π/4)e₂, where R₁₂, R₁₄, R₁₃ represent the usual clockwise rotations in the 1-2, 1-4, and 1-3 planes. The corresponding (lossless) interferometric configuration is depicted in FIGS. 2 and 3; the boxes standing for a 50:50 mixing. In FIG. 2, box 10 represents the rotation R₁₃ (π/4) box 12 the rotation R₁₂ (π/4) and box 13 the rotation R₁₃ (π/4). In FIG. 3 box 14 represents the rotation R₁₃ (−π/4), box 15 the rotation R₁₂ (−π/4), box 16 the rotation R₁₄ (−π/4) and box 17 the rotation R₁₃ (−π/4) realized by beam splitters and inverse beam splitters, respectively.

The encoding phase depicted in FIG. 2 consist of either inserting a particle into the first or the fourth terminal. Formally, its state undergoes the particular types of mixing transformations outlined above. Finally, the two upper and two lower exit terminals are subdivided into the two constituent states S₂ and S₁. The decoding phase depicted in FIG. 3 requires both shares S₂ and S₁, which are recombined in a reverse interferometric setup, in which the original states are reconstructed by performing the reverse mixings in reverse order.

Some configurations are not usable for secret sharing. The “worst case” scenario might be one in which the first share coincides with a basis vector of the orthonormal basis spanning R^{m}. In this case, the second share just consists of the remaining base states, making possible the detection of the original message. Take, for instance, the basis {(0,0,1), (0,1,0), (1,0,0)} which, when projected along the z-axis, results in the shares {(0,0,1)} and {(0,1,0), (1,0,0)}. These shares enable the parties to deterministically discriminate between the first state and the rest (first share), and between all states (second share).

A simple setup would correspond to a two-dimensional case, in which a particle would enter one of two input ports. A successive beam splitter would then scramble the original signal. In this setup, the two shares would just correspond to the two output ports of the beam splitter. Even though both parties would know that the other party would possess a one-dimensional share, due to phase coherence it would not be possible in a straightforward manner to reconstruct the secret message by manufacturing the missing one-component share.

As has already been pointed out, the proposed scheme does not necessarily involve entangled multipartite states; thus the parties are not given particles as shares. Rather, in the interferometric realization they are given interferometric channels; and in order to reconstruct the original message, it is important to keep quantum coherence among all the parties. Thus, in the encrypted stage, that is, before the decoding, no particle detection is allowed, since this would destroy coherence. The decoding transformation is the coherent combination of the two shares whose channels each correspond, respectively, to one and only one secret message.

The present invention shows possibilities to utilize the higher-dimensional components of the quantum state by combining two or more states defined in effectively lower-dimensional subspaces. Only after all parties have put their parts of the states together, are they able to decypher the message.

1. A method of communication using quantum cryptography, whereby the quantum states of single photons emitted by a light source and modulated by the information to be encrypted are transformed to a coherent superposition of at least two constituent states according to a unitary transformation, said at least two constituent states are transmitted in at least two separated quantum channels, and said at least two constituent states are recombined according to a transformation, which is inverse to said unitary transformation, and whereby the information is reconstructed of the recombined constituent states of the single-photon signal.

2. A method according to claim 1, whereby said single-photon signal is produced by a laser diode.

3. A method according to claim 1, whereby said at least two constituent states are transmitted via fiber optics.

4. A method according to claim 1, whereby said at least two constituent states are transmitted via free space links.

5. A method according to claim 1, whereby the quantum states of the single photons are transformed to a coherent superposition of at least two constituent states, and said at least two constituent states are recombined by beam-splitting.

6. A method according to claim 1, whereby the quantum states of the single photons are transformed to a coherent superposition of at least two constituent states, and said at least two constituent states are recombined by phase-shifting.

7. A system for communication using quantum cryptography comprising:
a) a light source for sending single-photon signals;
b) means for generating a signal modulating the single photon signals with the information, which should be encrypted;
c) means for transforming the single-photon signals to a coherent superposition of at least two constituent states according to a unitary transformation;
d) at least two transmitting channels for transmitting each of said at least two constituent states;
e) means for recombining said constituent states according to a transformation, which is inverse to said unitary transformation; and
f) means for reconstruction of said information of said recombined constituent states of the single-photon signal.

8. A communication system according to claim 7, whereby said means for transforming the single-photon signals and said means for recombining the constituent states according to the inverse unitary transformation comprises beam splitters.

9. A communication system according to claim 7, whereby said means for transforming the single-photon signals and said means for recombining the constituent states according to the inverse unitary transformation comprise phase modulators.

10. A communication system according to claim 7, whereby said light source is a laser diode.

11. A communication system according to claim 7, whereby said transmitting channels are made of fiber optics.

12. A communication system according to claim 7, whereby said transmitting channels are made of free space links.
